(19) United States
(12) Patent Application Publication
(10) Pub. No.: US 2003/0137310 A1
(43) Pub. Date: Jul. 24, 2003

(54) Remote viewing screen for test instrument

(76) Inventor: Thomas Holzel, Boston, MA (US)

Correspondence Address: Robert K. Tendler, 65 Atlantic Avenue, Boston, MA, 02110, US

(21) Appl. No.: 10/054,494

(22) Filed: Jan. 22, 2002

(51) Int. Cl. H01H 31/02

(52) U.S. Cl. 324/537

(57) ABSTRACT

A remote viewing screen such as an LCD screen is provided at a test probe which duplicates that which is seen on the display of the test instrument. The location of the remote screen on the probe permits the individual to probe a circuit or some other test point while at the same time looking at the results of the probing without having to shift one's gaze from the probe to the particular test instrument so that the individual doing the probing can maintain the probe at the correct location.

### FIELD OF INVENTION

This invention relates to displays and more particularly, to a remote display for test instruments.

### BACKGROUND OF THE INVENTION

As is often the case when testing circuits utilizing a probe or other type of test instrument, one has to move one's eyes from the point of contact between the point of the circuit being probed and the display on the test instrument to which the probe is connected, be it a multi-meter, oscilloscope or other type of device that displays either alpha-numeric indications of the test results or results in graphical form.

It will be appreciated that technicians testing a circuit have the continuing problem to keep having to look away from a tiny point that they are trying to probe to a display screen on the test instrument. What happens is that they often times lose the point of contact between the probe and the probed device. Additionally, an individual cannot actively probe to find a particular waveform without continuously looking back and forth between the probed sites and the test instrument.

Often times it is the case when looking back and forth between the probe tip and the testing instrument, that one can inadvertently short out a circuit which can destroy the circuit which one is probing.

Moreover, a probe need not be testing an integrated circuit but can, for instance, be testing continuity or in fact the presence of a predetermined voltage.

Especially with portable test equipment, one needs to check whether or not a fuse is blown and balancing a test meter while trying to probe the switch box is often times awkward because one is balancing the test instrument while at the same time trying to make the appropriate contact with the probe.

Thus, there may be no convenient test bench on which to locate the test instrument; but rather it can be hanging in the air or around his neck and not viewable when a technician is either out of doors or away from a test bench or table.

Such is the case for linemen who must ascend telephone poles or the like in order to test for various electrical conditions, be it for cable TV, electric power, or Internet connections.

In short, there is a requirement for the ability for a technician to be able to probe a given point and have a display of the results immediately visible, at that point without having to avert one's eyes to a different location when doing the probing.

While efforts have been made to miniaturize test equipment to the point where it can be portable enough to have a display built in to the probe, oftentimes it is not convenient, desirable or possible to miniaturize the test equipment in such a manner. Moreover, test equipment is often quite massive as in the case of oscilloscopes or waveform generating apparatus and it is therefore only with difficulty that one can reduce the size of the test equipment to handheld probe size.

Also, the weight of the test equipment can in some instances be an impediment if it is desired to build the test equipment into the probe, as the probes are manually manipulated and if heavy, are tiring to the individual seeking to utilize the test equipment. In addition, large test instruments take up valuable bench space.

### SUMMARY OF THE INVENTION

In order to provide technicians with more convenience, in one embodiment, a remote viewing screen is mounted to a probe, with the remote viewing screen being driven by test equipment that is not in the immediate vicinity of the probe. Thus, for instance, the output of an oscilloscope can be made available at the probe by replicating its display, with the oscilloscope function being provided by a piece of equipment that is on a lab test bench, rack-mounted or at least removed from the vicinity of the probe. Since the quality of the image which is a result of the probing is a function of the test instrument, the remote viewing screen may be coupled to an expensive oscilloscope or spectrum analyzer, with the image quality being that associated with the larger and more expensive test instrument. Or, a display with less resolution may suffice for the remote viewer.

Not only does the subject invention relate to oscilloscopes and the like, test instruments of all sorts are within the scope of the subject invention. Thus, when probing for conductivity or voltages which are sensed by a multimeter, the display of the multimeter is replicated at the probe so that the remote viewer is visually only a few degrees from the work area. As a result, the technician needs to move his or her eyes only a very slight distance to view the display. Moreover, the individual need not refocus his eye in order to go from the work point to the remote viewer display.

In another embodiment, the remote viewer screen can function as the main screen of a portable instrument, with the remote viewer screen being detachable so it can be removed from the instrument and driven remotely via a cable or wireless interface. Note that the remote viewer can either be attached to the probe or held adjacent the probe.

Thus, it will be appreciated that the manufacturer of a test instrument utilizing the subject invention does not have to supply two different screens but only a remote cable or wireless interface. As mentioned above, the screen can be nested in the housing for the test instrument and can be removed and clipped onto a probe.

In a further embodiment, the remote viewer can include a TV screen to allow repair technicians, for instance, to see the back of a circuit board they are soldering to. What is portrayed on the TV screen comes from a probe consisting of a miniature camera, for instance, to ascertain that solder has flowed correctly through the circuit board during the soldering operation.

The connection between the remote viewing screen and the test instrument can either be via a cable or can be, for instance, through a wireless interface such as Bluetooth, thereby providing the technician with a wireless link so as to minimize or eliminate the number of cables involved.

Note that while probing of electrical circuits is described herein, the subject invention is not limited to electrical circuits but rather includes any predetermined condition which can be probed such as temperature, pressure, radiation, sonography and other characteristics which can be measured by placing the requisite probe in a given area.

In summary, a remote viewing screen such as an LCD screen is provided at a test probe which duplicates that which is seen by the display on the test instrument. The location of the remote screen on the probe permits the individual to probe a circuit or some other point while at the same time looking at the results of the probing without having to shift one's gaze from the probe to the particular test instrument so that the individual doing the probing can maintain the probe at the correct location.

### BRIEF DESCRIPTION OF THE DRAWINGS

These and other features of the subject invention will be better understood in connection with the Detailed Description in conjunction with the Drawings, of which:

FIG. 1 is a diagrammatic illustration of the subject system including the attaching of a remote viewing display to a probe, with the probe attached to a test instrument and with the display being driven wirelessly by the test instrument to display the results of the probing;

FIG. 2 is a diagrammatic illustration of one embodiment of the subject invention in which the remote viewing display is initially housed within the test instrument and snaps out so as to be positioned at the probe of FIG. 1; and,

FIG. 3 is a diagrammatic illustration of a clip for clamping on the remote viewing screen to a probe.

### DETAILED DESCRIPTION:

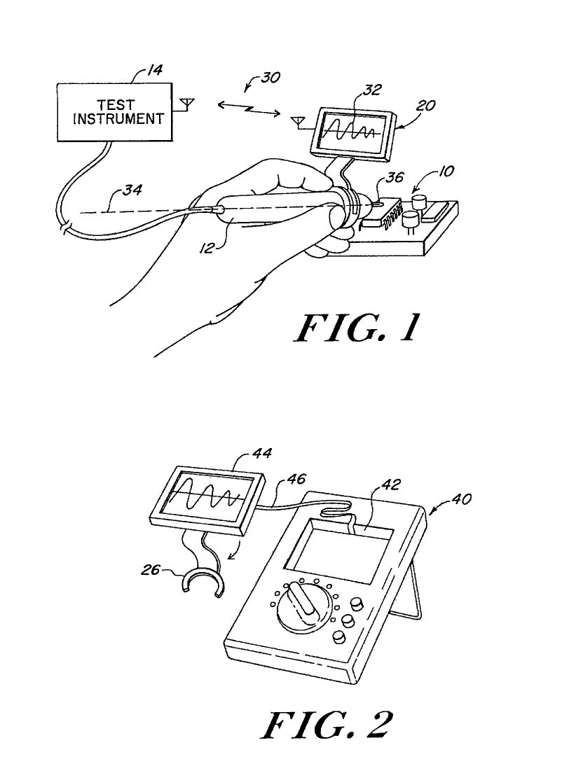

Referring now to FIG. 1, in one embodiment, a circuit 10 is probed by probe 12, which is coupled to a test instrument 14, that may, for instance, be an oscilloscope.

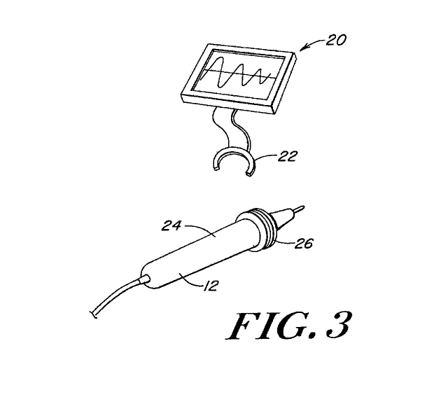

Clipped to probe 12 is a remote viewing display screen 20 which has, as illustrated in FIG. 3, a clip 22 which is attachable via spring loaded arms to a barrel 24 of probe 12 at an annular ring 26.

Referring back to FIG. 1, in one embodiment, remote viewing display 20 is wirelessly connected to test instrument 14 as illustrated at 30, such that when a particular point on circuit 10 is probed, a waveform 32 is displayed on the remote viewing screen, which in one embodiment is an LCD screen.

It will be appreciated that the remote viewing screen is in a direct line with the probe's central axis, here shown at 34, such that the tip 36 of probe 12 can be seen by the individual along with display 20 so that the display is within the field of view that includes tip 36. As a result, the eyes of the individual doing the probing do not have to refocus in order to view the displayed information.

What will be appreciated is that the individual can maintain tip 36 in contact with a predetermined portion of circuit 10 while at the same time viewing the results of the probing without having to avert his eyes to the test instrument and without having to refocus his eyes.

Referring now to FIG. 2, a test instrument 40 in the form of a multimeter is shown with a cavity or aperture 42 into which a remote viewing screen 44 is inserted. During normal operation of the multimeter, the screen functions normally and is connected to the circuits within the multimeter via cable 46. In this case, clip 26 is rotated backwardly and lies underneath display 44 when the display is within cavity 42.

When it is desired to remotely view the results of the testing procedure, then remote viewing screen 44 is removed from cavity 42 and clip 26 is made to extend down such that, as shown in FIG. 3, clip 26 engages a portion of probe 12 so as to locate the screen for convenient viewing.

What has therefore been provided is a remote viewer for a test instrument which may or may not have its own viewing screen. The remote viewing screen is electrically or wirelessly connected to the test instrument so that it can display the results of the probing.

The remote viewing screen is useful not only for probing circuits as mentioned above but maybe utilized in situations in which the test instrument is not within ready viewing of the probed position. Thus the results of the probing can be presented directly at the probe without having to provide the test instrument within the probe itself. Also, when probing a circuit for a particular waveform, the existence of this waveform is immediately displayed in the person's field of view so that an individual can quickly ascertain if the probed point is the correct point.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A system for permitting accurate probing of an area with a probe so as to permit viewing of the results of the probing without diverting one's gaze, comprising:
a test instrument;
a probe having a tip and coupled to said test instrument, said probe adapted to access a predetermined point on a test piece; and,
a remote viewing display coupled to said test instrument and mounted at said probe such that said display is within the field of view of an individual holding said probe and looking at the tip thereof, the tip of said probe and said display being viewable by said individual without averting the eyes of said individual; whereby said individual can be apprised of the results of probing by said probe without having to take his eyes off the tip of said probe.

2. The system of claim 1, wherein said display is mounted to said probe.

3. The system of claim 1, wherein said probe probes electrical signals.

4. The system of claim 1, wherein said remote viewing display is carried by said test instrument and is removable therefrom to be placed at said probe.

5. The system of claim 1, and further including a wireless transmitter for transmitting probe results from said test instrument to said display.

6. A method for conveniently viewing the results of an area probed by a probe connected to a test instrument, comprising the steps of:
providing a remote viewing display at said probe; and,
coupling the display to the test instrument, whereby probing results can be viewed while maintaining the probe tip in place.
